(19) United States
(12) Patent Application Publication
(10) Pub. No.: US 2019/0064452 A1
(43) Pub. Date: Feb. 28, 2019

(54) OPTICAL FIBER DEVICE

(71) Applicant: Molex, LLC, Lisle, IL (US)

(72) Inventor: Fan-Chen ZSENG, Taipei (TW)

(73) Assignee: Molex, LLC, Lisle, IL (US)

(21) Appl. No.: 16/103,597

(22) Filed: Aug. 14, 2018

(30) Foreign Application Priority Data
Aug. 25, 2017 (CN) 201721072440.3
Apr. 27, 2018 (CN) 201820622641.4

(51) Int. Cl. G02B 6/38

(52) U.S. Cl. CPC G02B 6/3885; G02B 6/3882; G02B 6/3825

(57) ABSTRACT

The present disclosure relates to an optical fiber device. The optical fiber device comprises an optical fiber apparatus. The optical fiber apparatus comprises an optical fiber module mounting groove, an optical fiber module and a cable connection module. The optical fiber module comprises a plurality of first optical fiber adapters, a plurality of first optical fiber connection units, a second optical fiber connection unit and a plurality of optical fibers. The plurality of first optical fiber adapters are provided to a front side of the optical fiber module. The plurality of first optical fiber connection units are connected with the plurality of first optical fiber adapters. The second optical fiber connection unit is provided to a rear side of the optical fiber module. The plurality of optical fibers are configured to connect the first optical fiber connection units and the second optical fiber connection unit. The cable connection module is independent from the optical fiber module. The cable connection module comprises a second optical fiber adapter. The second optical fiber adapter is provided to a rear end of the optical fiber module mounting groove and connected with the second optical fiber connection unit. Therefore when the optical fiber module is removed from the cable connection module, it will not pull the second external cable which has been organized and fixed of the second cable set. Accordingly, there is no need to worry about the problem of the cable organization.

### RELATED APPLICATIONS

This application claims priority to Chinese Application No. 201721072440.3, filed Aug. 25, 2017, and Chinese Application No. 201820622641.4, filed Apr. 27, 2018, both of which are incorporated herein by reference in their entirety.

### TECHNICAL FIELD

The present disclosure relates to an optical fiber device, particularly relates to an optical fiber device comprising an optical fiber module.

### BACKGROUND ART

FIG. 1 is a structural diagram of an existing optical fiber module, which is disclosed in Chinese patent application publication No. CN102460260A. Referring to FIG. 1, the optical fiber module 10 comprises a main body 102, an optical fiber 104, a LC (lucent connector) optical fiber adapter 105, a LC optical fiber connector 106, a MPO (multi-fiber push on) optical fiber connector 108, a MPO optical fiber adapter 110 and a dustproof pin 112. The MPO optical fiber adapter 110 is fixed and mounted to the main body 102 of the optical fiber module 10 through such as screws. In the example shown in FIG. 1, the optical fiber module 10 has not been connected to an external MPO optical fiber connector positioned outside the optical fiber module 10 and connected to an external cable. When the optical fiber module 10 is to be connected to the external MPO optical fiber connector positioned outside the optical fiber module 10 and connected to the external cable, the dustproof pin 112 is removed and the external MPO optical fiber connector is mounted to MPO optical fiber adapter 110 by the way that the dustproof pin 112 is mounted to the MPO optical fiber adapter 110, therefore the optical fiber module 10 is connected with the external cable outside the optical fiber module 10.

FIG. 2 is a structural diagram of an existing optical fiber device 70 comprising the optical fiber module 10 in FIG. 1. The optical fiber device 70 comprises an optical fiber device chassis 12 (hereinafter referred to as chassis 12). The chassis 12 is mounted in an optical fiber device rack 14. The optical fiber device rack 14 comprises two vertical rails 16A and 16B. The two rails 16A and 16B vertically extend and comprise a series of apertures 18, to help the chassis 12 to be attached inside the optical fiber device rack 14. The chassis 12 is attached to the optical fiber device rack 14 and supported by the optical fiber device rack 14 in the form of shelves which are stacked on top of each other within the two rails 16A and 16B. As shown in FIG. 2, the chassis 12 is attached to the two vertical rails 16A and 16B. The optical fiber device rack 14 can support 1-U-sized shelves, where “U” is equal to a standard 1.75 inch height and 19-inch width. In certain applications, the width of “U” may be 23 inches. Also, the term “optical fiber device rack” 14 should be understood to further comprise a cabinet structure. Because the optical fiber device 70 is the 1-U-sized specification, the optical fiber device 70 comprises twelve optical fiber modules 10 shown in FIG. 1. Accordingly, there will be twelve external cables which will be connected to the respective MPO optical fiber adapters 110 of the twelve optical fiber modules 10.

Because the MPO optical fiber adapter 110 is fixed and mounted to the main body of the optical fiber module 10 through such as screws, the MPO optical fiber adapters 110 of the optical fiber modules 10 need to be detached from the twelve external cables when the optical fiber modules 10 are detached from the twelve external cables. Also, because the twelve external cables are not better fixed, the twelve external cables will be easily pulled during the removing process that the MPO optical fiber adapters 110 of the optical fiber modules 10 are detached from the twelve external cables, even such that the external cable are entangled, and then it is necessary to further organize the external cables.

The description in background as above merely is used to provide a background art, and it does not admit that the description on the background art as above discloses the object of the present disclosure, and do not constitute a prior art of the present disclosure, and any description in background as above shall not be acted as any part of the present disclosure.

### SUMMARY

In an embodiment of the present disclosure, an optical fiber device comprises an optical fiber apparatus. The optical fiber apparatus comprises an optical fiber module mounting groove, an optical fiber module and a cable connection module. The optical fiber module is configured to be inserted into the optical fiber module mounting groove. The optical fiber module comprises a plurality of first optical fiber adapters, a plurality of first optical fiber connection units, a second optical fiber connection unit and a plurality of optical fibers. The plurality of first optical fiber adapters are provided to a front side of the optical fiber module. The plurality of first optical fiber connection units are connected with the plurality of first optical fiber adapters. The second optical fiber connection unit is provided to a rear side of the optical fiber module. The plurality of optical fibers are configured to connect the first optical fiber connection units and the second optical fiber connection unit. The cable connection module is independent from the optical fiber module. The cable connection module comprises a second optical fiber adapter. The second optical fiber adapter is provided to a rear end of the optical fiber module mounting groove and connected with the second optical fiber connection unit.

In an embodiment, a front end of the optical fiber module mounting groove comprises a groove opening, wherein the optical fiber module is configured to be inserted into the optical fiber module mounting groove from the groove opening.

In an embodiment, each first optical fiber connection unit comprises a first optical fiber connector connected to one of the first optical fiber adapters, and the second optical fiber connection units comprises a second optical fiber connector, the second optical fiber connector is configured to be connected to the second optical fiber adapter.

In an embodiment, each first optical fiber connection unit comprises a first optical fiber connector connected to one of the first optical fiber adapters, the second optical fiber connection unit comprises a third optical fiber adapter and a second optical fiber connector, wherein the third optical fiber adapter is configured to be connected to the second optical fiber adapter, the second optical fiber connector is connected to the second optical fiber adapter via the third optical fiber adapter.

In an embodiment, the optical fiber apparatus further comprises a clamping portion. The optical fiber module further comprises a clamped portion, wherein when the optical fiber module is inserted into the optical fiber module mounting groove, the optical fiber module is configured to be fixed to the optical fiber module mounting groove by that the clamping portion of the optical fiber apparatus clamps the clamped portion of the optical fiber module.

In an embodiment, the optical fiber apparatus further comprises a spring compression. The spring compression column is configured to store an elastic restoring force when the clamping portion of the optical fiber apparatus clamps the clamped portion of the optical fiber module, and apply the stored elastic restoring force to the optical fiber module when the clamping portion of the optical fiber apparatus releases the clamped portion of the optical fiber module to eject the optical fiber module.

In an embodiment, the optical fiber apparatus further comprises a chassis. The chassis comprises a pair of guide grooves, wherein the optical fiber module is mounted to the chassis through the pair of guide grooves. The cable connection module further comprises a back plate. The back plate is provided to the chassis and has an adapter mounting opening, wherein the second optical fiber adapter is mounted into the adapter mounting opening of the back plate and connected to the second optical fiber connector. Two sides of the optical fiber module are provided with two guide rails and slide in the pair of guide grooves through the two guide rails.

In an embodiment, each first optical fiber connection unit comprises a first optical fiber connector, and the second optical fiber connection unit comprises a second optical fiber connector. The optical fiber device further comprises a plurality of first external optical fiber connectors with the same type as the first optical fiber connectors and a second external optical fiber connector with the same type as the second optical fiber connector. The first optical fiber connectors are optically coupled to the first external optical fiber connectors positioned outside the optical fiber module through the first optical fiber adapters. The second optical fiber connector is optically coupled to the second external optical fiber connector positioned outside the optical fiber module through the second optical fiber adapter.

In an embodiment, the first optical fiber connector is a LC (Lucent connector) optical fiber connector, the second optical fiber connector is a MPO (multi-fiber push on) optical fiber connector, the first optical fiber adapter is a LC optical fiber adapter, and the second optical fiber adapter is a MPO optical fiber adapter.

In an embodiment, the optical fiber module comprises two positioning posts, and the back plate comprises a plurality of positioning holes. The optical fiber module is mounted to the back plate by a positioning way that the two positioning posts are cooperated with the two positioning holes of the plurality of positioning holes of the back plate.

In an embodiment, wherein the optical fiber device further comprises a second external cable and a string. The chassis comprises a retainer. A notch of the retainer is configured to accommodate the string surrounding a part of the second external cable extending out of the optical fiber apparatus, the string and the retainer cooperate to organize and fix the part of the second external cable extending out of the optical fiber apparatus to the retainer. The retainer is configured to change a routing direction of the part of the second external cable extending out of the optical fiber apparatus.

In an embodiment of the present disclosure, an optical fiber device comprises an optical fiber apparatus. The optical fiber apparatus comprises an optical fiber module mounting groove, an optical fiber module and a cable connection module. The optical fiber module is configured to be inserted into the optical fiber module mounting groove. The optical fiber module comprises a plurality of first optical fiber, a plurality of first optical fiber connection units, a second optical fiber connection unit and a plurality of optical fibers. The plurality of first optical fiber adapters are provided to a front side of the optical fiber module. The plurality of first optical fiber connection units are connected with the first optical fiber adapter. The second optical fiber connection unit is provided to a rear side of the optical fiber module. The plurality of optical fibers are configured to connect the first optical fiber connection units and the second optical fiber connection unit. The cable connection module is independent from the optical fiber module. The cable connection module comprises a second optical fiber adapter, wherein a connection of the second optical fiber adapter with an external cable connected to the optical fiber apparatus is not disconnected by that the optical fiber module exits from the optical fiber module mounting groove.

An existing optical fiber module is disclosed by Chinese Patent issuance Publication CN102460260A in the background. In architecture of the background, the optical fiber module is correspondingly connected to the external cable outside the optical fiber module through the MPO optical fiber adapter of the optical fiber module. Because the MPO optical fiber adapter is fixed and mounted to the main body of the optical fiber module through such as screws, the MPO optical fiber adapter of the optical fiber module needs to be detached from the external cable when the optical fiber module is detached from the external cable. Also, because the external cable is not better fixed, the external cable will be easily pulled during the removing process that the MPO optical fiber adapter of the optical fiber module is detached from the external cable, even such that entanglement of the external cable occurs, and then it is necessary to further organize the external cable. Furthermore, when the optical fiber device is 1-U-sized optical fiber device, there will be twelve external cables. Therefore, it is easier to pull the external cables, even be entangled. The entangled cables are prone to damage, which then affects the correctness of the signal.

Instead, in the present disclosure, because the second optical fiber adapter is not fixed to the optical fiber module but is fixed to the cable connection module of the optical fiber apparatus, when the optical fiber module is removed from the cable connection module, it only needs the second optical fiber connection unit to be detached from the second the optical fiber adapter fixed to the cable connection module of the optical fiber apparatus, it does not need that the second external optical fiber connector of the second cable set is detached from the second optical fiber adapter fixed to the cable connection module of the optical fiber apparatus. Therefore, it will not pull the second external cable which has been organized and fixed of the second cable set. Accordingly, there is no need to worry about the problem of the cable organization.

Technical features and advantages of the present disclosure are widely summarized as above, so as to better understand the following detailed description. Other technical features making up technical solutions of the claims of the present disclosure and other advantages will be described below. A person skilled in the art of the present disclosure shall understand that the concept and specific embodiments disclosed below may be easily used to modify or design other configuration or manufacturing approach so as to realize the same object as the present disclosure. A person skilled in the art of the present disclosure shall also understand that, such an equivalent configuration or approach cannot be departed from the spirit and scope of the present disclosure defined by the appended claims.

### BRIEF DESCRIPTION OF THE DRAWINGS

The various respects of the present disclosure may be best understood by the following detailed description taken in connection with the accompanying figures. It should be noted that, according to a standard implementing mode of the industries, features are not drawn as the scale. In practice, for the sake of clear explanation, various features may be arbitrarily enlarged or reduced in dimension.

FIG. 1 is a structural diagram of an existing optical fiber module.

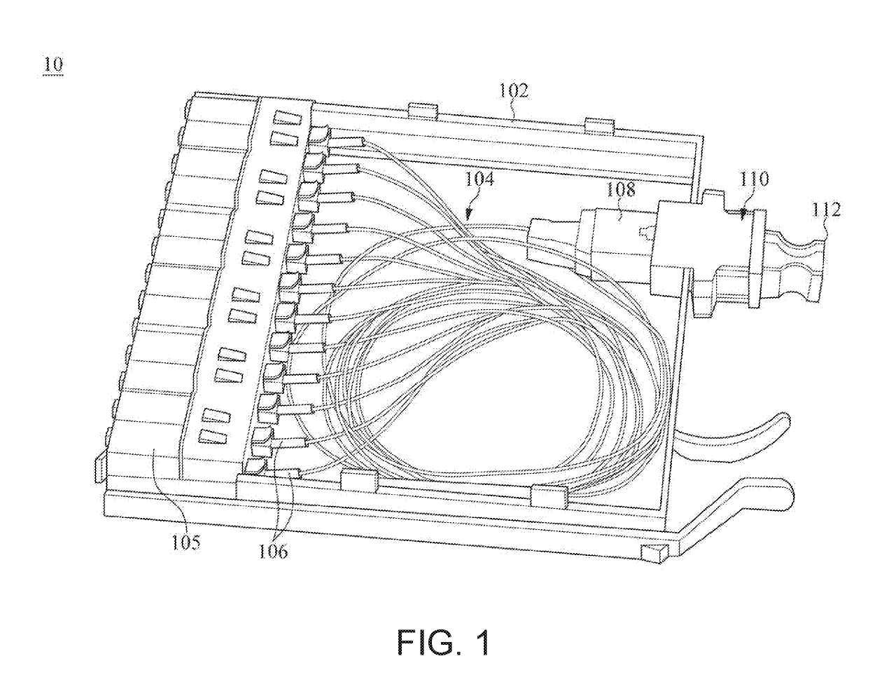

FIG. 2 is a structural diagram of an existing optical fiber device comprising the optical fiber module in FIG. 1.

FIG. 3 is a perspective view of an optical fiber device comprising an optical fiber apparatus of an embodiment in the present disclosure.

FIG. 4 is an assembled perspective view of the optical fiber device in FIG. 3 with a cover of the optical fiber device removed.

FIG. 5 is an exploded perspective view of the optical fiber device in FIG. 3 with the cover of the optical fiber device removed.

FIG. 6 is a perspective view of the optical fiber apparatus in FIG. 3.

FIG. 7 is a perspective view of the optical fiber apparatus in FIG. 3 from another angle.

FIG. 8 is an assembled perspective view of an optical fiber module in FIG. 3.

FIG. 9 is an exploded perspective view of the optical fiber module in FIG. 3.

FIG. 10 is a perspective view illustrating a structure of the optical fiber device after the optical fiber modules are removed.

FIG. 11 is a perspective view of the optical fiber apparatus connected to an external optical fiber connector of another embodiment in the present disclosure.

FIG. 12 is a perspective view illustrating that the optical fiber modules exit from an optical fiber module mounting groove of the optical fiber apparatus in FIG. 11.

FIG. 13 is a perspective view illustrating that the optical fiber modules exit from the optical fiber module mounting groove of the optical fiber apparatus in FIG. 12 from another angle.

FIG. 14 is an exploded perspective view of the optical fiber module in FIG. 11.

FIG. 15 is a perspective view illustrating that a cable connection module in FIG. 11 is provided to a chassis.

FIG. 16 is an exploded perspective view of the cable connection module in FIG. 11.

FIG. 17 is an exploded perspective view of a clamping portion in FIG. 11.

### DETAILED DESCRIPTION OF THE PREFERRED EMBODIMENTS

The following disclosed content provides various embodiments or exemplifications used to implement various features of the present disclosure. Specific examples of elements and arrangements are described as follows, so as to simplify the disclosed content of the present disclosure. Certainly, these are merely examples, and are not used to limit the present disclosure. For example, in the following description, that a first feature is formed on or above a second feature may comprise an embodiment that the first feature and the second feature are formed to directly contact with each other, may also comprise an embodiment that other feature is formed between the first feature and the second feature, therefore the first feature and the second feature do not directly contact with each other. Moreover, the present disclosure may allow a symbol and/or a character of an element to be repeated in different examples. The repetition is used for simplification and clearness, but is not used to dominate a relationship between various embodiments and/or discussed structures.

Moreover, the present disclosure may use spatial corresponding terminologies, such as “below”, “lower than”, “relative lower”, “higher than”, “relative high” and the like, so as to describe a relationship between an element or feature and another element or feature. Spatial corresponding terminologies are used to comprise various orientations of a device in use or operation besides orientations illustrated in figures. The device may be orientated (rotated by 90 degrees or at other orientation), and the corresponding spatial description in the present disclosure may be correspondingly explained. It should be understood that, when a feature is formed to another feature or above a substrate, other feature may presented between them.

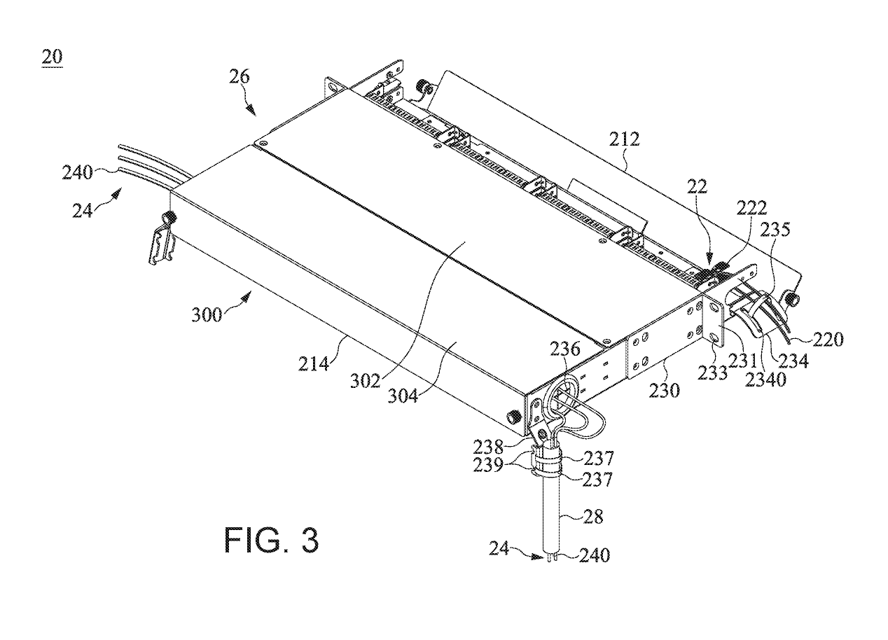

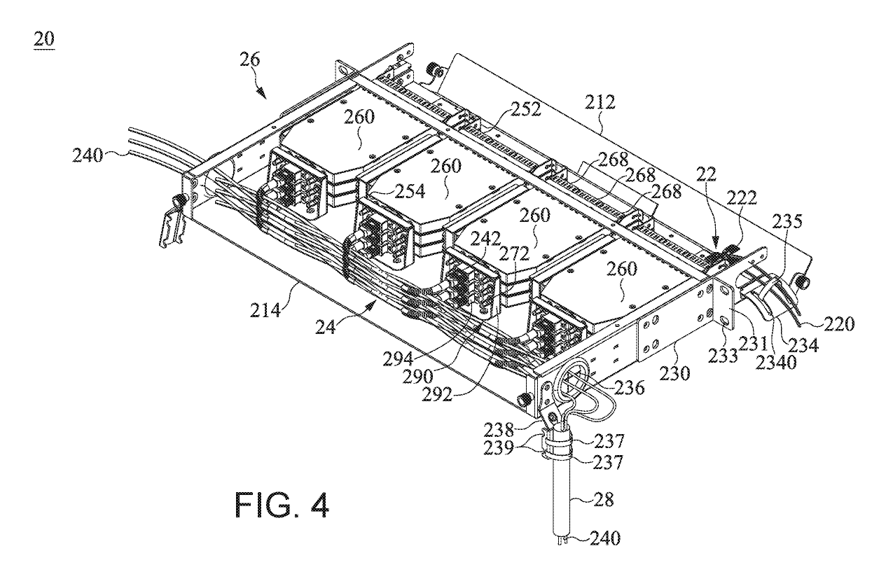

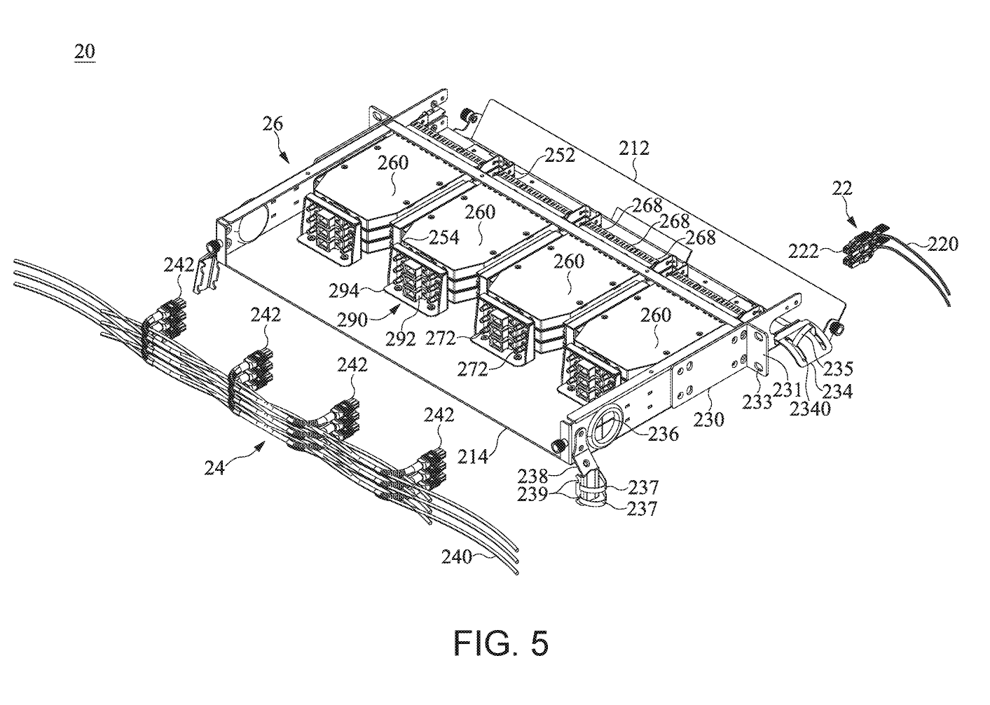

FIG. 3 is a perspective view of an optical fiber device 20 comprising an optical fiber apparatus 26 of an embodiment in the present disclosure. FIG. 4 is an assembled perspective view of the optical fiber device 20 in FIG. 3 with a cover 300 of the optical fiber device 20 removed, the cover 300 comprises a top cover 302 and a rear cover 304. FIG. 5 is an exploded perspective view of the optical fiber device 20 in FIG. 3 with the cover 300 of the optical fiber device 20 removed. The cover 300 of the optical fiber apparatus 26 is omitted in FIG. 4 and FIG. 5 in order to clarify the internal structure of the optical fiber apparatus 26. Referring to FIG. 3 to FIG. 5, the optical fiber device 20 comprises a first cable set 22, a second cable set 24 and an optical fiber apparatus 26. The first cable set 22 and the second cable set 24 are connected to the optical fiber apparatus 26.

The optical fiber apparatus 26 comprises a chassis 230, a plurality of optical fiber modules 260, a plurality of cable connection modules 290 and a cover 300. The cover 300 is configured to cover the plurality of optical fiber modules 260. The plurality of optical fiber modules 260 are provided on the chassis 230, and are connected to the second cable set 24 through the plurality of cable connection modules 290. The plurality of optical fiber module 260 support high-density optical fiber modules and optical fiber connection density and bandwidth connection in a given space (which comprises a 1-U space).

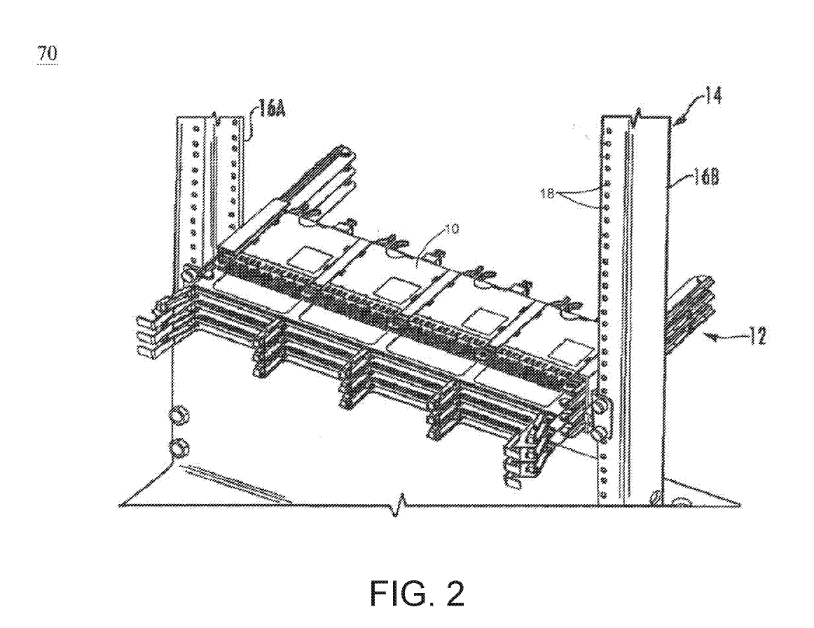

A configuration of the optical fiber device 20 will be described briefly below. The optical fiber device 20 can further comprise an optical fiber device rack as an optical fiber device rack 14 in FIG. 2. The optical fiber device rack comprises two vertical rails shown as rails 16A and 16B in FIG. 2. The two rails extend vertically and comprise a series of apertures as apertures 18 in FIG. 2, to allow screw holes 233 of an erecting plate 231 of the chassis 230 to be correspondingly screwed and in turn allow the chassis 230 to be attached inside the optical fiber device rack. In the embodiment, the chassis 230 is 1-U-sized. However, the present disclosure is not limited thereto. The chassis 230 also can be provided with a size larger than 1-U.

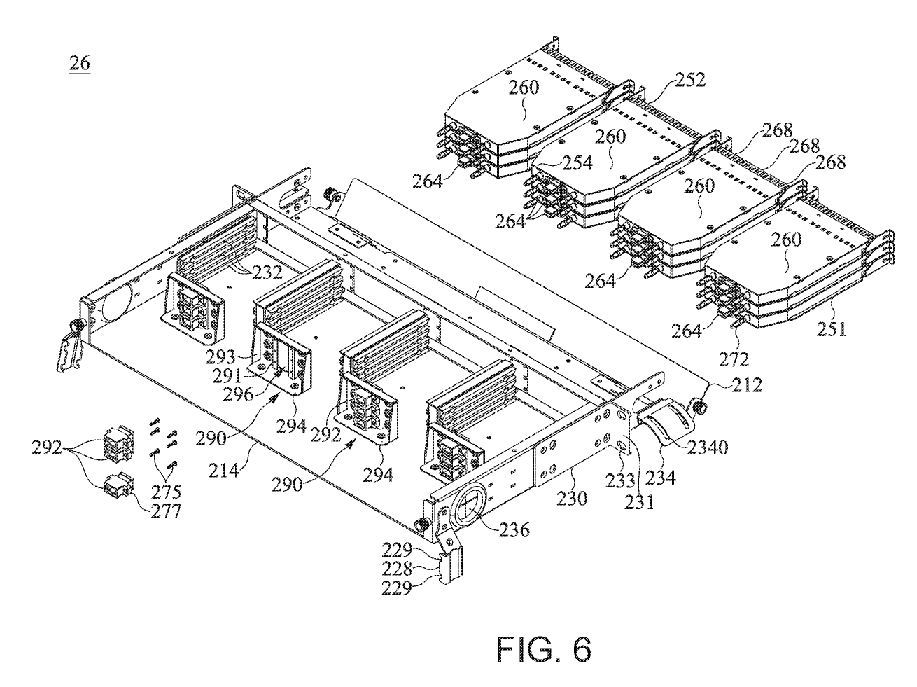

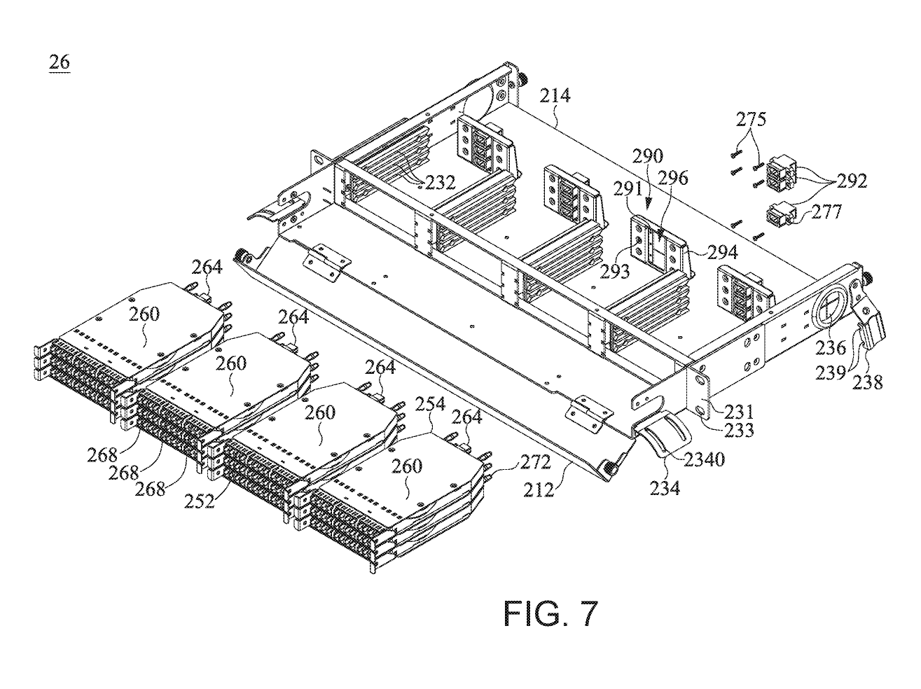

FIG. 6 is a perspective view of the optical fiber apparatus 26 in FIG. 3. FIG. 7 is a perspective view of the optical fiber apparatus 26 in FIG. 3 from another angle. Referring to FIG. 6 and FIG. 7, in the embodiment, the optical fiber apparatus 26 comprises twelve optical fiber modules 260, and the twelve optical fiber modules 260 are divided into four sets, each set comprises three optical fiber modules 260. Because the optical fiber modules 260 is divided into four sets, the optical fiber apparatus 26 comprises four sets of cable connection modules 290 corresponding to the four sets of optical fiber modules 260. However, the present disclosure is not limited thereto, the combinations of various numbers of optical fiber modules 260 and cable connection modules 290 are not departed from the scope of the present disclosure. For sake of convenience, in the following description, a set of optical fiber modules 260 and a set of cable connection modules 290 are described where appropriate. Also, a single optical fiber module 260 of a set of optical fiber modules 260 and a set of cable connection modules 290 are described where appropriate, and the quantifiers “a single” and “a set of” will be omitted where appropriate in order to simplify description.

Referring to FIG. 6 and FIG. 7, the chassis 230 has a front side 212 and a rear side 214. The optical fiber module 260 has a front side 252 and a rear side 254 respectively corresponding to the front side 212 and the rear side 214 of the chassis 230. The optical fiber module 260 is mounted in the chassis 230 with the rear side 254 of the optical fiber module 260 along the front side 212 of the chassis 230 toward the rear side 214 of the chassis 230, but the specific mounting manner will be described in detail below.

The cable connection module 290 is independent from the optical fiber module 260. As mentioned above, in the embodiment, a set of optical fiber modules comprises multiple optical fiber modules 260. Accordingly, a set of cable connection modules 290 comprises multiple second optical fiber adapters 292 corresponding to a set of optical fiber modules. In an embodiment, the second optical fiber adapter 292 is a MPO optical fiber adapter. Furthermore, the set of cable connection modules 290 further comprises a back plate 294. In the embodiment, the four sets of cable connection modules 290 each have the respective back plate 294. However, the present disclosure is not limited thereto, in other embodiments, four sets cable connection modules 290 share a back plate.

The back plate 294 is provided on the chassis 230, and has an adapter mounting opening 296. The adapter mounting opening 296 is configured to receive the second optical fiber adapter 292 when the second optical fiber adapter 292 is mounted on the back plate 294. More specifically, the back plate 294 has multiple screw holes 291, and the multiple second optical fiber adapters 292 have multiple through holes 277. The optical fiber apparatus 26 further comprises a plurality of screws 275. The screw 275 passes through the through hole 277 on the second optical fiber adapter 292 and the screw hole 291 on the back plate 294, and thereby the second optical fiber adapter 292 is screwed and fixed to the back plate 294. However, the present disclosure is not limited thereto. In some embodiments, the optical fiber apparatus 26 further can comprise a plurality of nuts. The screw 275 passes through the through hole 277 and the screw hole 291 in the foregoing manner, and cooperates with the nut to screw and fix the second optical fiber adapter 292 to the back plate 294.

Because the second optical fiber adapter 292 is not mounted to the optical fiber module 260, there is no need to worry about cable organization during the process that the optical fiber module 260 is inserted into the chassis 230 and removed from the chassis 230, which will be descrambled in more detail below.

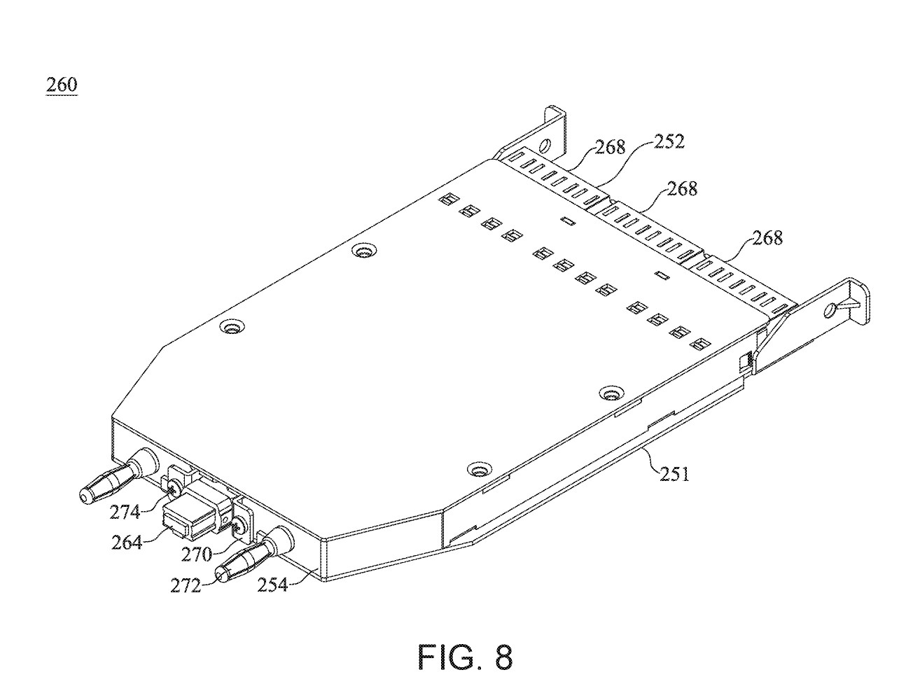

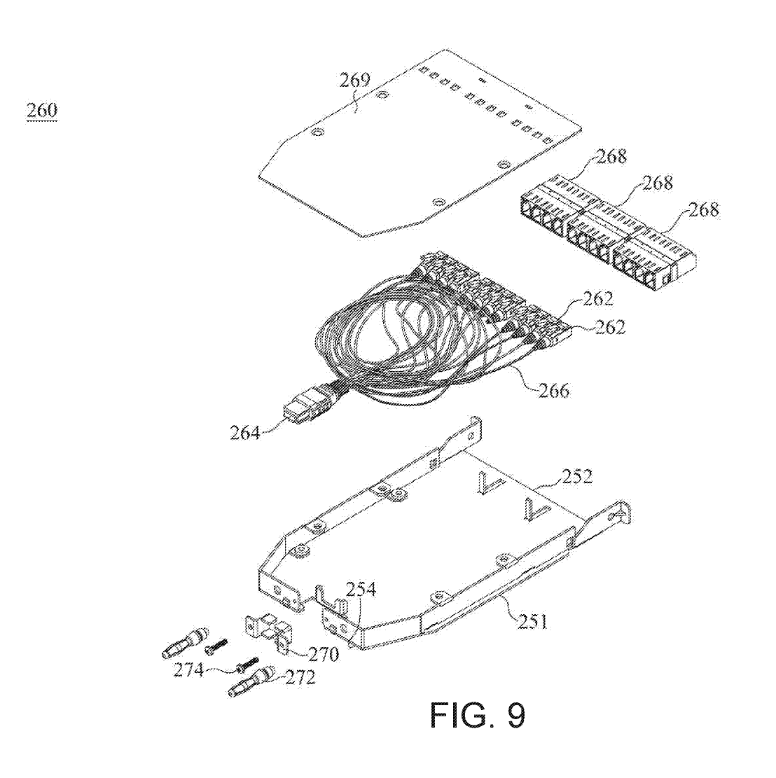

FIG. 8 is an assembled perspective view of the optical fiber module 260 in FIG. 3. FIG. 9 is an exploded perspective view of the optical fiber module 260 in FIG. 3. Referring to FIG. 8 and FIG. 9, the optical fiber module 260 comprises a plurality of first optical fiber connection units 262, a second optical fiber connection unit 264, a plurality of optical fibers 266, a plurality of first optical fiber adapters 268, an upper cover 269, an accommodating part 270, two positioning posts 272 and two screws 274. In the embodiment, the first optical fiber connection unit 262 comprises a first optical fiber connector; and the second optical fiber connection unit 264 comprises a second optical fiber connector. In the following description of the embodiment, any one of the first optical fiber connection unit and the first optical fiber connector can be represented by the reference numeral 262 where appropriate. Similarly, any one of the second optical fiber connection unit and the second optical fiber connector can be represented by the reference numeral 264.

The plurality of first optical fiber connectors 262 are connected to the plurality of first optical fiber adapters 268. The plurality of first optical fiber adapters 268 are provided at the front side 252 of the optical fiber module 260. The second optical fiber connector 264 is provided at the rear side 254 of the optical fiber module 260. The plurality of optical fibers 266 are configured to connect the plurality of first optical fiber connectors 262 and the second optical fiber connector 264.

In order to describe the connection of the optical fiber module 260 with the external cable outside the optical fiber module 260, referring to FIG. 4 and FIG. 5 again, the first cable set 22 comprises a first external cable 220 and a first external optical fiber connector 222. A second cable set 24 comprises a second external cable 240 and a second external optical fiber connector 242.

The first optical fiber connector 262 is optically coupled to the first external optical fiber connector 222 via the first optical fiber adapter 268, the first external optical fiber connector 222 is positioned outside the optical fiber module 260 and has the same type as the first optical fiber connector 262. In an embodiment, the first optical fiber adapter 268 is a LC optical fiber adapter, the first optical fiber connector 262 is a LC optical fiber connector, and the first external optical fiber connector 222 is a LC optical fiber connector.

The second optical fiber connector 264 is optically coupled to the second external optical fiber connector 242 via the second optical fiber adapter 292 on the back plate 294, the second external optical fiber connector 242 is positioned outside the optical fiber module 260 and has the same type as the second optical fiber connector 264. In an embodiment, the second optical fiber connector 264 is a MPO optical fiber connector, the second optical fiber adapter 292 is a MPO optical fiber adapter, the second external optical fiber connector 242 is a MPO optical fiber connector.

The accommodating part 270 is configured to accommodate the second optical fiber connector 264, and fixed to a housing of the optical fiber module 260 through the two screws 274. In the embodiment, the accommodating part 270 is formed of two components. However, the present disclosure is not limited thereto. In other embodiments, the accommodating part 270 is formed of one component. The two positioning posts 272 are used for positioning. Specifically, referring to FIG. 6 and FIG. 7 again, the back plate 294 comprises a plurality of positioning holes 293. The optical fiber module 260 is mounted to the back plate 294 by a positioning way that the two positioning posts 272 are cooperated with the two positioning holes 293 of the plurality of positioning holes 293 of the back plate 294. When the optical fiber module 260 is mounted to the chassis 230, the second optical fiber connector 264 is connected to the second optical fiber adapter 292 mounted to the back plate 294.

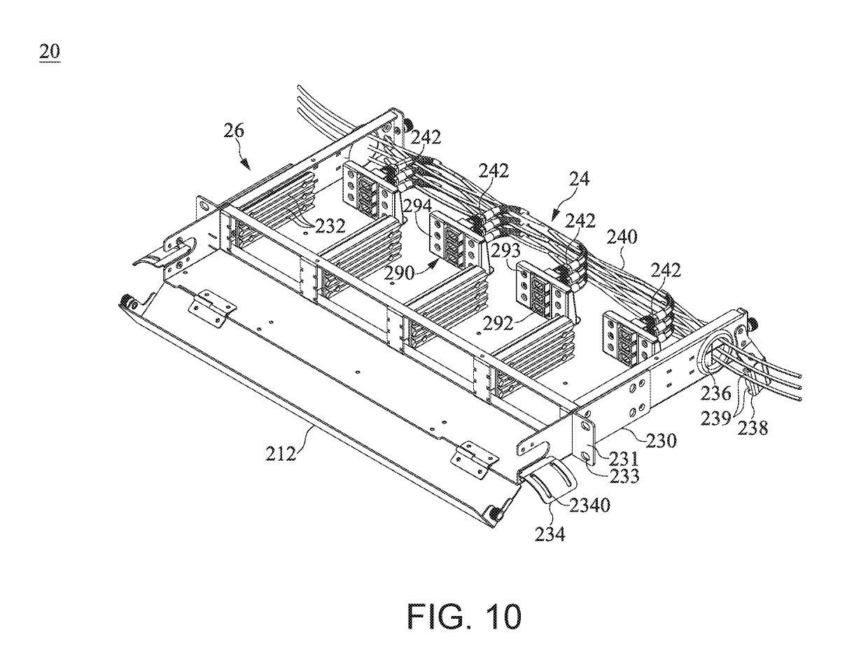

FIG. 10 is a perspective view illustrating a structure of the optical fiber device 20 after the optical fiber modules 260 are removed. Referring to FIG. 10, in the present disclosure, because the second optical fiber adapter 292 is not mounted to the optical fiber module 260 but is mounted to the back plate 294, when the optical fiber module 260 is removed from the chassis 230, it only needs the second optical fiber connector 264 to be detached from the second optical fiber adapter 292 mounted on the back plate 294, there is no need to make the second external optical fiber connector 242 of the second cable set 24 is detached from the second optical fiber adapter 292 mounted on the back plate 294. Therefore, it will not pull the second external cable 240 of the second cable set 24 which has been organized and fixed. Accordingly, there is no need to worry about the cable organization.

Furthermore, referring to FIG. 4, FIG. 5 and FIG. 10, the chassis 230 comprises multiple pairs of guide grooves 232, an arc piece 234, a through hole 236, and a retainer 238. Each pair of guide grooves 232 is configured to guide the optical fiber module 260 when the optical fiber module 260 is mounted into the chassis 230. More specifically, while referring to FIG. 8 and FIG. 9, two protruding ribs extend outwardly from two sides of a lower plate of the optical fiber module 260 respectively, the two protruding ribs function as guide rails 251 on the two sides of the optical fiber module 260. The guide rails 251 of the optical fiber module 260 respectively slide in the guide grooves 232, therefore the optical fiber module 260 is mounted into the chassis 230 or removed from the chassis 230.

The arc piece 234 is configured to organize and fix a part of the first external cable 220 of the first cable set 22 exposed outside the optical fiber apparatus 26. More specifically, an opening 2340 of the arc piece 234 is configured to make a string 235 surrounding the first external cable 220 to pass through, the string 235 and the arc piece 234 cooperate to organize and fix the part of the first external cable 220 of the first cable set 22 exposed outside the optical fiber apparatus 26 to the arc piece 234. Furthermore, the through hole 236 is configured to make a part of the second external cable 240 of the second cable set 24 extend out of the optical fiber apparatus 26. The retainer 238 is configured to arrange and fix the part of the second external cable 240 of the second cable set 24 extending out of the optical fiber apparatus 26. More specifically, a notch 239 of the retainer 238 is configured to accommodate a string 237 surrounding the part of the second external cable 240, the string 237 and the retainer 238 cooperate to organize and fix the part of the second external cable 240 extending out of the optical fiber apparatus 26 to the retainer 238. The retainer 238 has a rotation function, thereby changing the routing direction of the second external cable 240 extending out of the optical fiber apparatus 26 when the rotation of the retainer 238 is performed, so that the cable organization is more convenient. Furthermore, the second external cable 240 extending out of the optical fiber apparatus 26 can be protected by an insulating layer 28.

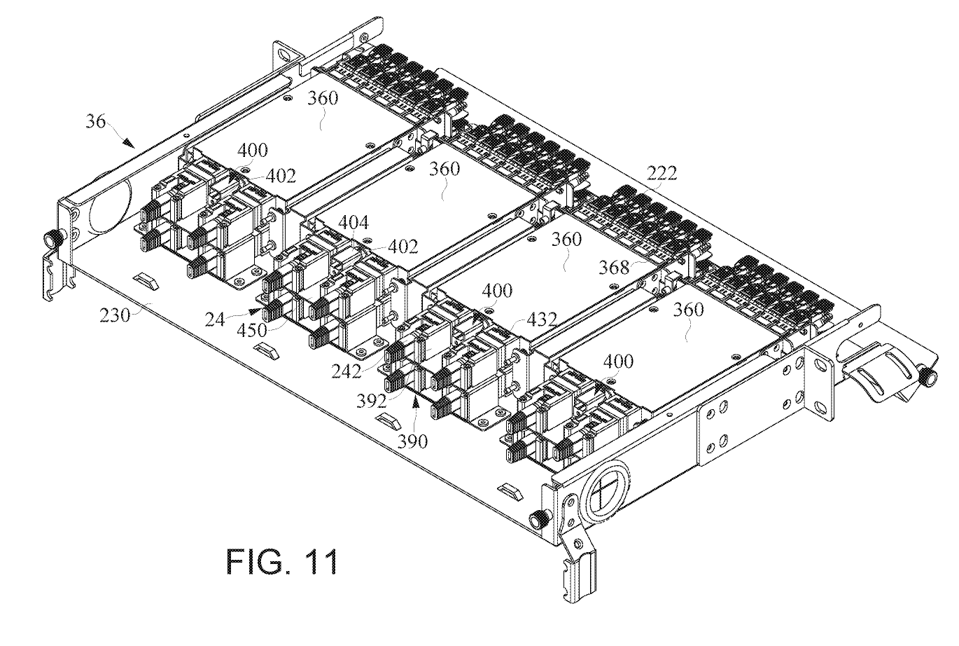

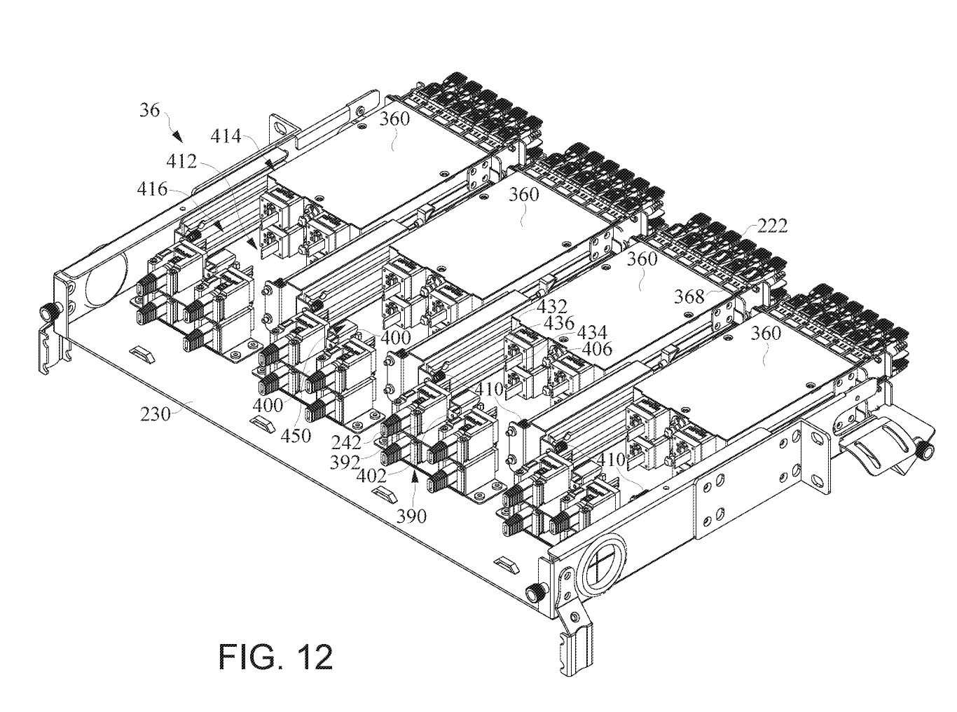

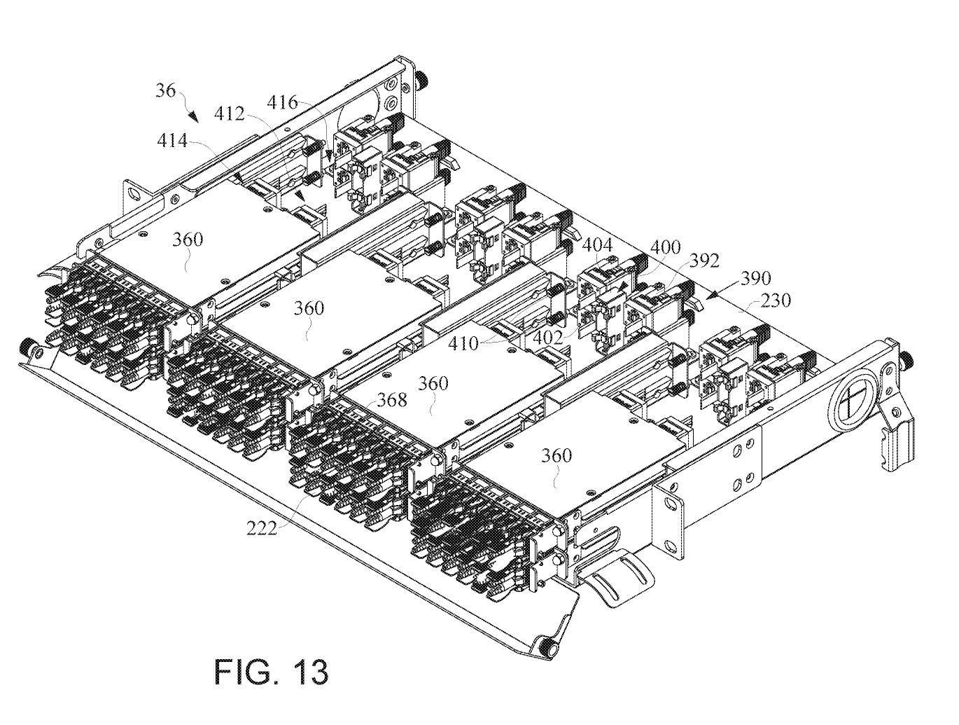

FIG. 11 is a perspective view of an optical fiber apparatus 36 connected to external optical fiber connectors (first external optical fiber connectors 222 and second external optical fiber connectors 242) of another embodiment in the present disclosure. FIG. 12 is a perspective view illustrating that the optical fiber module 360 exits from an optical fiber module mounting groove 412 of the optical fiber apparatus 36 in FIG. 11. FIG. 13 is a perspective view illustrating that the optical fiber module 360 exits from the optical fiber module mounting groove 412 of the optical fiber apparatus 36 in FIG. 12 from another angle. Referring to FIG. 11 to FIG. 13, the first external cable 220 of the first cable set 22 and the second external cable 240 of the second cable set 24 are not shown in figures for sake of brevity.

The optical fiber apparatus 36 is similar to the optical fiber apparatus 26 shown in FIG. 3, the difference is that the optical fiber apparatus 36 comprises a plurality of optical fiber modules 360 and a plurality of cable connection modules 390. Furthermore, the optical fiber apparatus 36 and the optical fiber apparatus 26 in FIG. 3 both have a plurality of optical fiber module mounting grooves. For the convenience of describing the optical fiber apparatus 36, the optical fiber module mounting groove of the optical fiber apparatus 36 is represented as a reference numeral 412. In the embodiment, the optical fiber apparatus 36 comprises eight optical fiber modules 360, and the eight optical fiber modules 360 are divided into four sets, each set comprises two optical fiber modules 360. Because the optical fiber modules 360 are divided into four sets, the optical fiber apparatus 36 comprises four sets of cable connection modules 390 corresponding to the four sets of optical fiber modules 360. However, the present disclosure is not limited thereto, and the combinations of various numbers of optical fiber modules 360 and cable connection modules 390 are not departed from the scope of the present disclosure. For sake of convenience, in the following description, a set of optical fiber modules 360 and a set of cable connection modules 390 are described where appropriate. Also, a single optical fiber module 360 of the set of optical fiber modules 360 and a set of cable connection modules 390 are described where appropriate, and the quantifiers “a single” and “a set of” will be omitted where appropriate in order to simplify illustration.

The optical fiber module 360 is configured to be inserted from a groove opening at a font end 414 of the optical fiber module mounting groove 412 into the optical fiber module mounting groove 412. A rear end 416 of the optical fiber module mounting groove 412 is close to the cable connection module 390 relative to the font end 414.

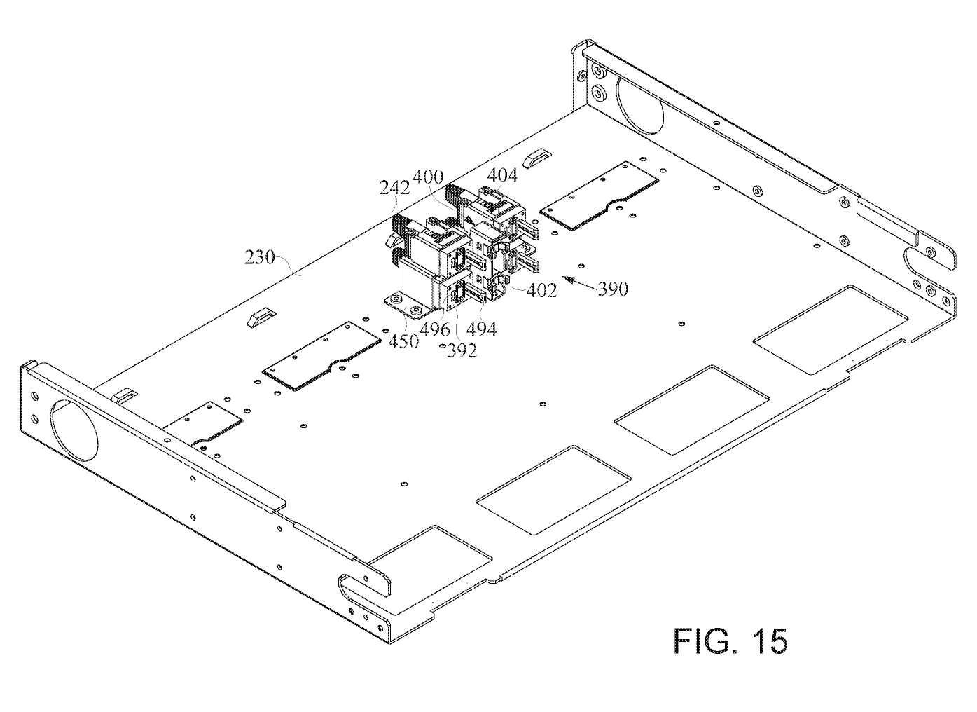

The cable connection module 390 is independent from the optical fiber module 360. The cable connection module 390 is configured to connect the second cable set 24, and the connection between the cable connection module 390 and the second cable set 24 of the optical fiber apparatus 36 will not be disconnected by that the optical fiber module 360 exits from the optical fiber module mounting groove 412. Therefore, it will not pull the second external cable 240 of the second cable set 24 that have been organized and fixed. Accordingly, there is no need to worry about the cable organization. The structure of the cable connection module 390 will be illustrated in detail in FIG. 15.

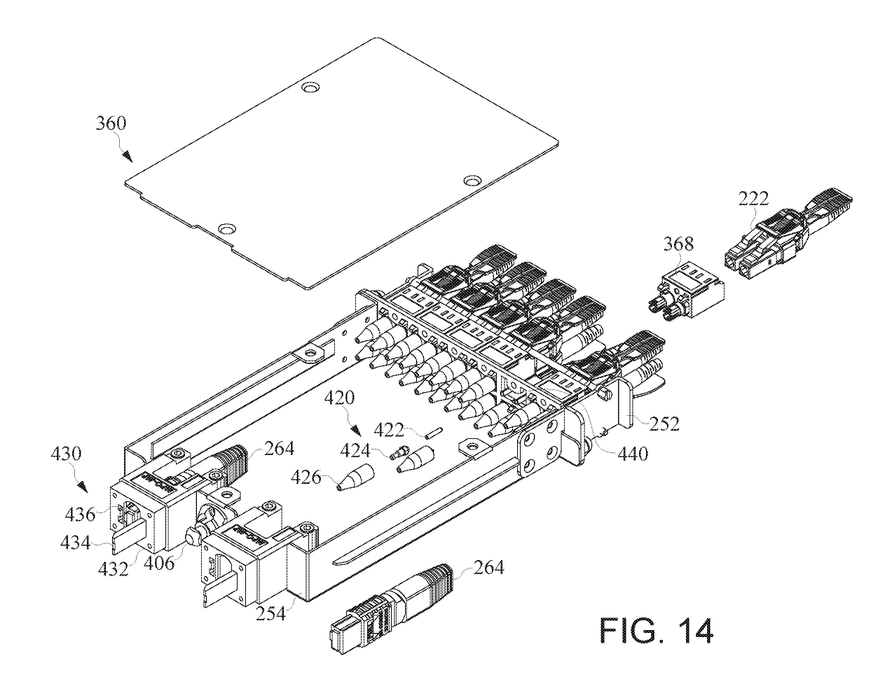

FIG. 14 is an exploded perspective view of the optical fiber module 360 in FIG. 11. FIG. 15 is a perspective view illustrating that the cable connection module 390 in FIG. 11 is provided to a chassis. Referring to FIG. 14, in order to highlight the relationship between the optical fiber module 360 and the first external optical fiber connector 222 of the first cable set 22, one first external optical fiber connector 222 is separated and illustrated. The optical fiber module 360 is similar to the optical fiber module 260 illustrated in FIG. 9, the difference is that the optical fiber module 360 comprises a plurality of first optical fiber adapters 368, a plurality of first optical fiber connection units 420, a second optical fiber connection unit 430. The detailed structures of the first optical fiber adapter 368 and the first optical fiber connection unit 420 can refer to Chinese Patent issuance Publication No. CN206479676U.

The first optical fiber connection unit 420 is connected with the first optical fiber adapter 368 provided to the front side 252 of the optical fiber module 360. In some embodiments, the first optical fiber connection unit 420 comprises a first optical fiber connector. Compared to a receptacle structure with slots respectively on two opposite sides, a structure of an optical fiber receptacle of the first optical fiber adapter 368 in the embodiment almost is decreased by half, which reduces volume and substantially reduces material costs. Furthermore, in the embodiment that the first optical fiber connection unit 420 comprises the first optical fiber connector, the first optical fiber connector can also substantially reduce the number of components, thereby not only saving material costs, but also reducing manufacturing man-hours. Specifically, the first optical fiber connector, for example, only comprises a ferrule 422, a holder 424, and a sheath 426. Also, in the embodiment, the first optical fiber adapter 368 is fixed in the optical fiber module 360 through a faceplate 440. The optical fiber receptacles of the first optical fiber adapters 368 are provided in two rows in an up-down direction, and the upper row and the lower row of the optical fiber receptacles make bottom walls of the first optical fiber adapters 368 adjacent to each other, and the optical fiber receptacles in the same row make side walls of the first optical fiber adapters 368adjacent to each other, so that the optical fiber receptacles of the first optical fiber adapters 368 are densely arranged, which substantially reduces the area of the faceplate 440 occupied by the first optical fiber adapters 368, and increases the number of the optical fiber receptacles on the faceplate 440, that is, more optical fiber interfaces can be inserted and more optical fiber can be accommodated. However, the present disclosure is not limited thereto, and the first optical fiber adapters 368 can be fixed in the optical fiber module 360 in any suitable way.

The second optical fiber connection unit 430 is provided to the rear side 254 of the optical fiber module 360. The second optical fiber connection unit 430 comprises a plurality of third optical fiber adapters 432 and a plurality of second optical fiber connectors 264. In the embodiment, the second optical fiber connection unit 430 comprises two third optical fiber adapters 432 and two second optical fiber connectors 264. However, the present disclosure is not limited thereto, the combinations of various numbers of third optical fiber adapters 432 and second optical fiber connectors 264 will not be departed from the scope of the present disclosure. For sake of convenience, in the following description, a single third optical fiber adapter 432 and a single second optical fiber connector 264 will be described where appropriate, and in order to simplify description, the quantifier a “a single” will be omitted where appropriate. The third optical fiber adapter 432 is configured to connect the cable connection module 390.

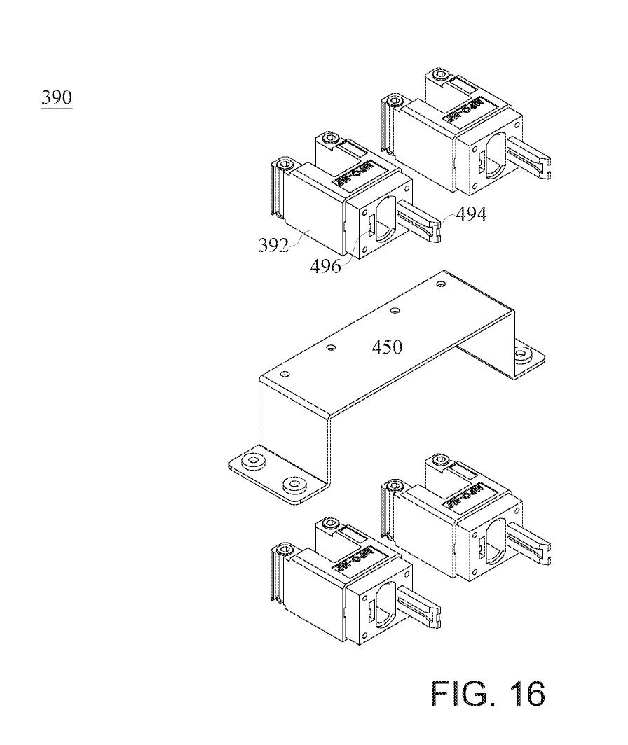

FIG. 16 is an exploded perspective view of the cable connection module 390 in FIG. 11. The cable connection module 390 is similar to the cable connection module 290 illustrated in FIG. 10, the difference is that the cable connection module 390 comprises a plurality of second optical fiber adapters 392 and an erecting plate 450. The number of components of the set of cable connection modules 390 is shown in FIG. 16. The set of cable connection modules 390 comprises four second optical fiber adapters 392. However, the present disclosure is not limited thereto, and the number can be adjusted for different designs. While referring to FIGS. 15 and 16, the two second optical fiber adapters 392 are provided on the chassis 230 to be connected with one optical fiber module 360 positioned on the chassis 230, the other two second optical fiber adapters 392 are provided on the erecting plate 450 to be connected with another optical fiber module 360 positioned on the one optical fiber module 360.

The second optical fiber adapter 392 of the cable connection module 390 is connected to the third optical fiber adapter 432 of the optical fiber module 360, such that the second optical fiber connector 264 is connected to the second optical fiber adapter 392 of the cable connection module 390 via the third optical fiber adapter 432. The structure of the third optical fiber adapter 432 is essentially the same as the second optical fiber adapter 392. For sake of convenient description, the internal structure of the third optical fiber adapter 432 will be represented by a reference numeral which is different from the internal structure of the second optical fiber adapter 392 where appropriate.

Referring to FIGS. 14 and 15 again, the optical fiber module 360 is connected to the cable connection module 390 by a positioning way that a positioning post 434 of the third optical fiber adapter 432 of the optical fiber module 360 is positioned in a positioning hole 496 of the second optical fiber adapter 392 of the cable connection module 390 and a positioning post 494 of the second optical fiber adapter 392 of the cable connection module 390 is positioned in a positioning hole 436 of the third optical fiber adapter 432 of the optical fiber module 360. This positioning way allows for greater tolerances when manufacturing the optical fiber apparatus 36.

Also, referring to FIG. 11 to FIG. 12 again, in the embodiment, the optical fiber apparatus 36 further comprises a clamping portion 400, and the optical fiber module 360 further comprises a clamped portion 406. When the optical fiber module 360 is inserted into the optical fiber module mounting groove 412, the optical fiber module 360 is configured to be fixed to the optical fiber module mounting groove 412 by that the clamping portion 400 of the optical fiber apparatus 36 clamps the clamped portion 406 of the optical fiber module 360. However, the present disclosure is not limited thereto. The clamping portion 400 and the clamped portion 406 are optional. In addition, in the present disclosure, the optical fiber module 360 can be fixed to the optical fiber module mounting groove 412 by other way.

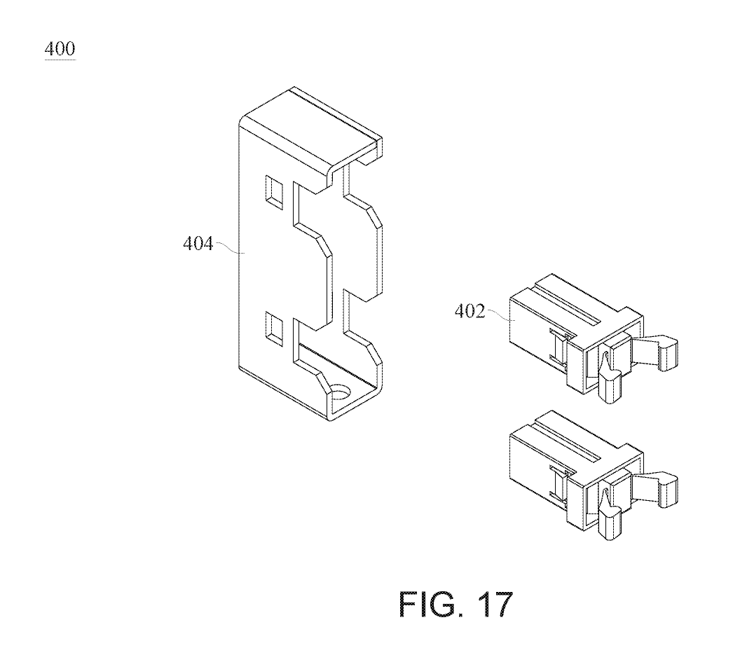

FIG. 17 is an exploded perspective view of a clamping portion in FIG. 11. Referring to FIG. 17, the clamping portion 400 comprises a plurality of latches 402 and a housing 404. In the embodiment, the clamping portion 400 comprises two latches 402, the latch 402 on the upper side latches the clamped portion 406 of the optical fiber module 360 on the upper side, and the latch 402 on the lower side latches the clamped portion 406 of the optical fiber module 360 on the lower side. However, the present disclosure is not limited thereto. In some embodiments, the clamped portion 406 of the optical fiber module 360 comprises a door catch. In some embodiments, the clamped portion 406 of the optical fiber module 360 and the clamping portion 400 of the optical fiber apparatus 36 cooperate to define a push-push structure. In the embodiment, the push-push structure means that the clamping portion 400 of the optical fiber apparatus 400 clamps the clamped portion 406 of the optical fiber module 360 when the optical fiber module 360 is pushed toward the cable connection module 390 for the first time. In the state of the clamping, when the optical fiber module 360 is pushed toward the cable connection module 390 again, the clamping portion 400 of the optical fiber apparatus 36 releases the clamped portion 406 of the optical fiber module 360.

Also, referring to FIG. 11 to FIG. 12 again, in some embodiments, the optical fiber apparatus 36 further comprises a plurality of spring compression columns 410. The spring compression column 410 is configured to eject the optical fiber module 360 when the optical fiber module 360 exits from the optical fiber module mounting groove 412.Specifically, followed the above, when the optical fiber module 360 is pushed toward the cable connection module 390 for the first time to make that the clamping portion 400 of the optical fiber apparatus 36 clamps the clamped portion 406 of the optical fiber module 360, the optical fiber module 360 will compress the spring compression column 410 to make the spring compression column 410 store an elastic restoring force. When the optical fiber module 360 is pushed toward the cable connection module 390 again to make that the clamping portion 400 of the optical fiber apparatus 36 releases the clamped portion 406 of the optical fiber module 360, the spring compression column 410 will apply the stored elastic restoring force to the optical fiber module 360, thereby ejecting the optical fiber module 360.

However, the present disclosure is not limited thereto. In some embodiments, the spring compression column 410 is optional.

An existing optical fiber module 10 is disclosed by Chinese Patent issuance Publication CN102460260A in the background. In architecture of the background, the optical fiber module 10 is correspondingly connected to the external cable outside the optical fiber module 10 through the MPO optical fiber adapter 110 of the optical fiber module. Because the MPO optical fiber adapter 110 is fixed and mounted to the main body of the optical fiber module 10 through such as screws, the MPO optical fiber adapter 110 of the optical fiber module 10 needs to be detached from the external cable when the optical fiber module 10 is detached from the external cable. Also, because the external cable is not better fixed, the external cable will be easily pulled during the removing process that the MPO optical fiber adapter 110 of the optical fiber module 10 is detached from the external cable, even such that entanglement of the external cable occurs, and then it is necessary to further organize the external cable. Furthermore, when the optical fiber device 70 is 1-U-sized optical fiber device, there will be twelve external cables. Therefore, it is easier to pull the external cables, even be entangled. The entangled cables are prone to damage, which then affects the correctness of the signal.

Instead, in the present disclosure, because the second optical fiber adapter 292 or 392 is not fixed to the optical fiber module 260 or 360 but is fixed to the cable connection module 290 or 390 of the optical fiber apparatus 26 or 36, when the optical fiber module 260 or 360 is removed from the cable connection module 290 or 390, it only needs the second optical fiber connection unit 264 or 430 to be detached from the second the optical fiber adapter 292 or 392 fixed to the cable connection module 290 or 390 of the optical fiber apparatus 26 or 36, it does not need that the second external optical fiber connector 242 of the second cable set 24 is detached from the second optical fiber adapter 292 or 392 fixed to the cable connection module 290 or 390 of the optical fiber apparatus 26 or 36. Therefore, it will not pull the second external cable 240 which has been organized and fixed of the second cable set 24. Accordingly, there is no need to worry about the problem of the cable organization.

Features of some embodiments are summarized in above content, so that a person skilled in the art may better understand various aspects of the disclosed content of the present disclosure. A person skilled in the art of the present disclosure shall understand that the disclosed content of the present disclosure may be easily used to design or modify other manufacturing approach or configuration and in turn to realize the same object and/or attain the same advantage as the embodiments of the present disclosure. A person skilled in the art of the present disclosure shall also understand that, such an equivalent approach or configuration cannot be departed from the spirit and scope of the disclosed content of the present disclosure, and a person skilled in the art may make various changes, substitutions and replacements, which are not departed from the spirit and scope of the disclosed content of the present disclosure.

What is claimed is:

1. An optical fiber device, comprising:
an optical fiber apparatus comprising:
an optical fiber module mounting groove;
an optical fiber module configured to be inserted into the optical fiber module mounting groove, the optical fiber module comprising:
a plurality of first optical fiber adapters provided to a front side of the optical fiber module;
a plurality of first optical fiber connection units connected with the plurality of first optical fiber adapters;
a second optical fiber connection unit provided to a rear side of the optical fiber module; and
a plurality of optical fibers configured to connect the first optical fiber connection units and the second optical fiber connection unit; and
a cable connection module independent from the optical fiber module, the cable connection module comprising:
a second optical fiber adapter provided to a rear end of the optical fiber module mounting groove and connected with the second optical fiber connection unit.

2. The optical fiber device according to claim 1, wherein a front end of the optical fiber module mounting groove comprises a groove opening, wherein the optical fiber module is configured to be inserted into the optical fiber module mounting groove from the groove opening.

3. The optical fiber device according to claim 1, wherein each first optical fiber connection unit comprises a first optical fiber connector connected to one of the first optical fiber adapters, and wherein the second optical fiber connection units comprises a second optical fiber connector, the second optical fiber connector is configured to be connected to the second optical fiber adapter.

4. The optical fiber device according to claim 1, wherein each first optical fiber connection unit comprises a first optical fiber connector connected to one of the first optical fiber adapters, wherein the second optical fiber connection unit comprises a third optical fiber adapter and a second optical fiber connector, wherein the third optical fiber adapter is configured to be connected to the second optical fiber adapter, the second optical fiber connector is connected to the second optical fiber adapter via the third optical fiber adapter.

5. The optical fiber device according to claim 4, wherein
the optical fiber apparatus further comprises a clamping portion; and the optical fiber module further comprises a clamped portion,
wherein when the optical fiber module is inserted into the optical fiber module mounting groove, the optical fiber module is configured to be fixed to the optical fiber module mounting groove by that the clamping portion of the optical fiber apparatus clamps the clamped portion of the optical fiber module.

6. The optical fiber device according to claim 5, wherein the optical fiber apparatus further comprises:
a spring compression column configured to store an elastic restoring force when the clamping portion of the optical fiber apparatus clamps the clamped portion of the optical fiber module, and apply the stored elastic restoring force to the optical fiber module when the clamping portion of the optical fiber apparatus releases the clamped portion of the optical fiber module to eject the optical fiber module.

7. The optical fiber device according to claim 3, wherein
the optical fiber apparatus further comprises: a chassis comprising a pair of guide grooves, wherein the optical fiber module is mounted to the chassis through the pair of guide grooves; and
the cable connection module further comprises: a back plate provided to the chassis, and having an adapter mounting opening, wherein the second optical fiber adapter is mounted into the adapter mounting opening of the back plate and connected to the second optical fiber connector,
wherein two sides of the optical fiber module are provided with two guide rails and slide in the pair of guide grooves through the two guide rails.

8. The optical fiber device according to claim 7, wherein the first optical fiber connector is a LC optical fiber connector, the second optical fiber connector is a MPO optical fiber connector, the first optical fiber adapter is a LC optical fiber adapter, and the second optical fiber adapter is a MPO optical fiber adapter.

9. The optical fiber device according to claim 1,
wherein each first optical fiber connection unit comprises a first optical fiber connector, and the second optical fiber connection unit comprises a second optical fiber connector,
wherein the optical fiber device further comprises a plurality of first external optical fiber connectors with the same type as the first optical fiber connectors and a second external optical fiber connector with the same type as the second optical fiber connector,
wherein the first optical fiber connectors are optically coupled to the first external optical fiber connectors positioned outside the optical fiber module through the first optical fiber adapters, and the second optical fiber connector is optically coupled to the second external optical fiber connector positioned outside the optical fiber module through the second optical fiber adapter.

10. The optical fiber device according to claim 9, wherein the first optical fiber connector is a LC optical fiber connector, the second optical fiber connector is a MPO optical fiber connector, the first optical fiber adapter is a LC optical fiber adapter, and the second optical fiber adapter is a MPO optical fiber adapter.

11. The optical fiber device according to claim 7, wherein the optical fiber module comprises two positioning posts, and the back plate comprises a plurality of positioning holes, the optical fiber module is mounted to the back plate by a positioning way that the two positioning posts are cooperated with the two positioning holes of the plurality of positioning holes of the back plate.

12. The optical fiber device according to claim 7,
wherein the optical fiber device further comprises a second external cable and a string,
wherein the chassis comprises a retainer, a notch of the retainer is configured to accommodate the string surrounding a part of the second external cable extending out of the optical fiber apparatus, the string and the retainer cooperate to organize and fix the part of the second external cable extending out of the optical fiber apparatus to the retainer and the retainer is configured to change a routing direction of the part of the second external cable extending out of the optical fiber apparatus.

13. An optical fiber device, comprising:
an optical fiber apparatus comprising:
an optical fiber module mounting groove;
an optical fiber module configured to be inserted into the optical fiber module mounting groove, the optical fiber module comprising:
a plurality of first optical fiber adapters provided to a front side of the optical fiber module;
a plurality of first optical fiber connection units connected with the first optical fiber adapter;
a second optical fiber connection unit provided to a rear side of the optical fiber module; and
a plurality of optical fibers configured to connect the first optical fiber connection units and the second optical fiber connection unit; and
a cable connection module independent from the optical fiber module, the cable connection module comprising:
a second optical fiber adapter, wherein a connection of the second optical fiber adapter with an external cable connected to the optical fiber apparatus is not disconnected by that the optical fiber module exits from the optical fiber module mounting groove.
